(19) United States
(12) Patent Application Publication
(10) Pub. No.: US 2022/0373732 A1
(43) Pub. Date: Nov. 24, 2022

(54) CONNECTOR FOR MULTI-CORE FIBER

(71) Applicant: COMMSCOPE TECHNOLOGIES LLC, Hickory, NC (US)

(72) Inventors: Jan WATTÉ, Grimbergen (BE); Saurav KUMAR, Gent (BE); Danny Willy August VERHEYDEN, Gelrode (BE); Vivek PANAPAKKAM VENKATESAN, Leuven (BE); Koen VANMOL, Vilvoorde (BE); Jürgen Albert Jan VAN ERPS, Tervuven (BE)

(73) Assignee: COMMSCOPE TECHNOLOGIES LLC, Hickory, NC (US)

(21) Appl. No.: 17/761,133

(22) PCT Filed: Sep. 16, 2020
(86) PCT No.: PCT/US2020/051080

§ 371 Date: Mar. 16, 2022

Related U.S. Application Data
(60) Provisional application No. 62/900,848, filed on Sep. 16, 2019.

(51) Int. Cl. G02B 6/02; G02B 6/38; G02B 6/36

(52) U.S. Cl. CPC G02B 6/02042; G02B 6/387; G02B 6/3628; G02B 6/3885

(57) ABSTRACT

An optical device that includes a multicore optical fiber having at least two cores. An alignment feature is attached at the first end of the first multicore optical fiber. The device also includes a substrate having at least two waveguides, each waveguide comprising a redirecting feature. A fiber holder is located on the substrate to hold the multicore fiber in a correct axially rotational orientation using the alignment feature, so that light couples between the cores of the multicore fiber and respective waveguides in the substrate.

### CROSS-REFERENCE TO RELATED APPLICATION

This application is being filed on Sep. 16, 2020 as a PCT International Patent Application and claims the benefit of U.S. Patent Application Ser. No. 62/900,848, filed on Sep. 16, 2019, the disclosure of which is incorporated herein by reference in its entirety.

### BACKGROUND OF THE INVENTION

The present invention is generally directed to optical communications, and more specifically to improved methods for increasing the information transmission capacity for a single optical fiber.

Historically, several steps have been taken to improve the information transmission bandwidth in single mode fiber (SMF) optical communications systems, which are typically used for transmitting information over distances of a kilometer or more. Low transmission loss silica fibers were developed in the late 1970s and early 1980s, permitting the use of silica fibers over greater distances. The advent of erbium-doped fiber amplifiers (EDFAs), providing amplification for signals around 1550 nm, permitted the transmission of signals over even greater distances, while the introduction of wavelength division multiplexing/demultiplexing (WDM) extended the bandwidth of silica fibers by permitting a single mode silica fiber to carry different optical signals at different wavelengths. Optical communication systems have further benefitted from the introduction of advanced techniques such as polarization multiplexing and higher order modulation schemes to increase spectral efficiency (bits/s/Hz). However, current SMF optical transmission systems are now approaching their intrinsic capacity limits, and it is expected that they will be unable to meet future capacity requirements.

One approach being considered for increasing fiber capacity is space division multiplexing (SDM), in which different optical signals are physically (spatially) separated from each other within the same fiber. One particular implementation of SDM is to use a multi-core fiber (MCF), in which a number of different cores, typically single-mode cores, are contained within the same cladding material, laterally separated from each other within the cladding. Thus, a single MCF having, for example five individual single mode cores, can carry five times the data of a single mode fiber, which can reduce the costs of data transport.

One complication with MCF, however, its connectivity: the multiple cores require precise rotational alignment of the fiber end about the fiber axis in order for the cores to be aligned to another MCF or to a waveguide array. This can be particularly a problem for a technician assembling an MCF system in the field.

The invention described herein is directed to an approach to simplifying the connectivity of an MCF.

### SUMMARY OF THE INVENTION

An embodiment of the invention is directed to an optical device that includes a first multicore optical fiber having at least two cores laterally separated from each other within a cladding. The first multicore optical fiber has a first end. An alignment feature is attached on the first multicore fiber at the first end of the first multicore optical fiber. The device also includes a substrate comprising at least two waveguides, each of the at least two waveguides comprising a redirecting feature. A fiber holder is located on the substrate, the fiber holder being configured to receive the first multicore optical fiber and comprising an alignment channel to receive the alignment feature. When the first multicore optical fiber is in an aligned position within the fiber holder, the first multicore optical fiber is rotationally aligned around its axis by an interaction between the alignment feature on the first multicore fiber and the alignment channel of the holder so that the at least two cores are aligned to optically couple light between the at least two cores and respective redirecting features of the at least two waveguides.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A schematically illustrates an embodiment of an optical communications system that uses space division multiplexing in a multi-core fiber to propagate optical communications signals, according to the present invention;

FIG. 1B schematically illustrates another embodiment of an optical communications system that uses space division multiplexing in a multi-core fiber to propagate optical communications signals, according to the present invention;

FIG. 2A schematically illustrates an embodiment of a multicore fiber having seven single-mode cores;

FIG. 2B schematically illustrates an embodiment of a multicore fiber having three multimode cores and a single mode core;

FIG. 3 schematically illustrates an optical chip multiplexer/demultiplexer for coupling light between a plurality of single mode fibers and a multicore fiber, according to an embodiment of the present invention;

FIG. 4 schematically illustrates a fiber holder on an optical chip for end-coupling between a multicore fiber held in the fiber holder and waveguides on the optical chip, according to an embodiment of the present invention;

FIG. 5 schematically illustrates a cross section of the channel in the fiber holder that receives the multicore fiber and its alignment feature, according to an embodiment of the present invention;

FIG. 6 schematically illustrates an alignment feature 3-D printed on the end of a multicore fiber, according to an embodiment of the present invention;

FIG. 7 schematically illustrates a cross-sectional view through a fiber holder according to an embodiment of the present invention;

FIG. 8 schematically illustrates an end-coupled multicore fiber having an angled end, coupled to an optical chip according to an embodiment of the present invention;

FIGS. 9A and 9B schematically illustrate axial rotation of a seven core multicore fiber to achieve equal separation between adjacent pairs of waveguides in the optical chip, according to an embodiment of the present invention;

FIGS. 9C and 9D respectively schematically illustrate axial rotation of a four and a five core multicore fiber to achieve equal separation between adjacent pairs of waveguides in the optical chip, according to an embodiment of the present invention;

FIG. 10 schematically illustrates a multicore fiber side-coupling between the multicore fiber and an optical chip, with light coupling between cores of the multicore fiber and respective waveguides of the optical chip via reflection off the end face of the multicore fiber, according to an embodiment of the present invention;

FIG. 11 schematically illustrates the angled end of a multicore fiber for side-coupling between the multicore fiber and the chip, according to an embodiment of the present invention;

FIGS. 12A-12C schematically illustrates a multicore fiber for side-coupling to a chip, according to an embodiment of the present invention;

FIGS. 13A-13D schematically illustrate a fiber housing on an optical chip and multicore fiber arranged for side-coupling to the optical chip, according to an embodiment of the present invention;

FIG. 14 schematically illustrates an embodiment of a system employed to rotationally align a multicore fiber before an alignment feature is applied to it, according to the present invention;

FIG. 15 schematically illustrates an embodiment of a system employed to fabricate the alignment feature on the multicore fiber using 2-photon femtosecond 3-D printing, according to the present invention;

FIG. 16 schematically illustrates an embodiment of a system employed to apply a preliminary low-profile alignment marker to a multicore fiber, according to the present invention;

FIG. 17 schematically illustrates a multicore fiber-multicore fiber coupler according to an embodiment of the present invention;

FIG. 18 schematically illustrated an add/drop filter, according to an embodiment of the present invention;

FIG. 19A schematically illustrates a fiber coupler for direct coupling between multicore fibers with printed alignment features, according to an embodiment of the present invention; and

FIG. 19B schematically illustrates the fiber coupler of FIG. 19A, with the multicore fibers in aligned positions within the fiber coupler so that light can couple between respective cores of the two multicore fibers.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is largely directed to the provision of a keying feature on a multicore fiber (MCF) that is used to correctly align the cores of an MCF to an array of waveguides on an optical chip. Such a device may find use in optical communications systems for providing increased data handling capacity.

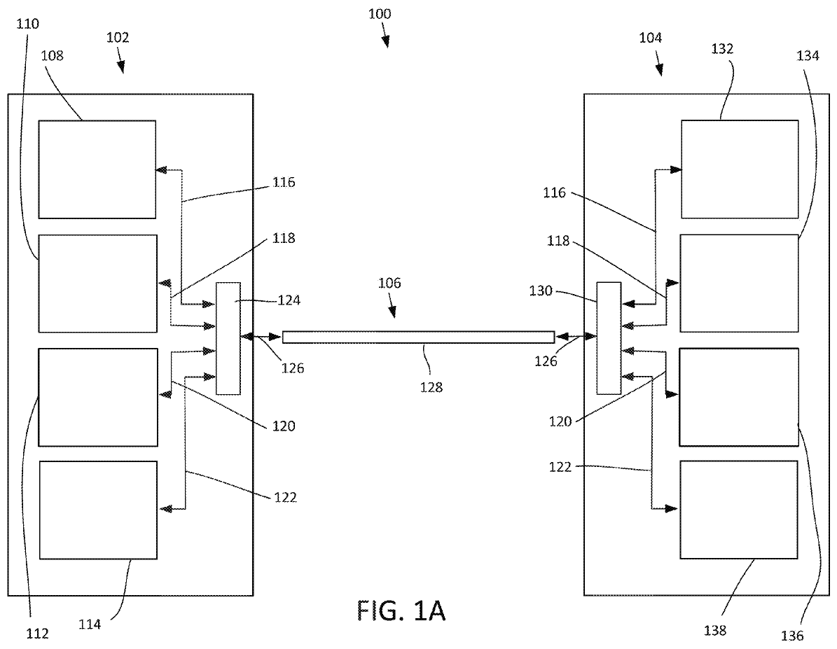

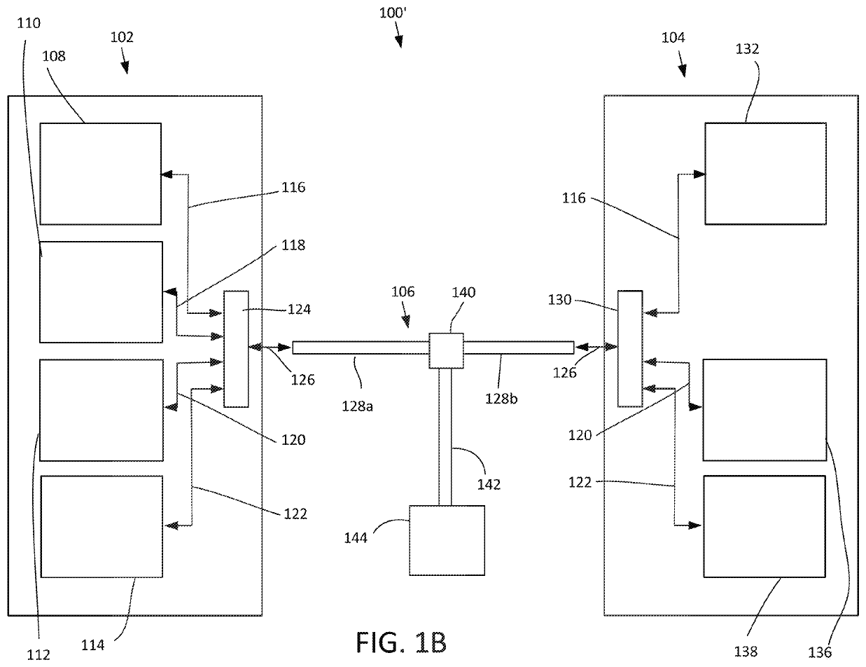

An exemplary embodiment of an optical communication system 100 is schematically illustrated in FIG. 1A. The optical communication system 100 generally has a transmitter portion 102, a receiver portion 104, and a fiber optic portion 106. The fiber optic portion 106 is coupled between the transmitter portion 102 and the receiver portion 104 for transmitting an optical signal from the transmitter portion 102 to the receiver portion 104.

In this embodiment, the optical communication system 100 uses space division multiplexing (SDM) to increase the data capacity of the fiber portion 106. Optical signals are generated within the transmitter portion 102 and are combined into different cores of a multicore fiber (MCF) 128 in the optical fiber portion 106 and are transmitted to the receiver portion 104, where the signals that propagated along different fiber cores are spatially separated and directed to respective detectors. The illustrated embodiment shows an optical communication system 100 that spatially multiplexes four different signals into four different cores of the fiber 128a, although it will be appreciated that optical communications systems may spatially multiplex different number of signals, e.g. two, three or more than four.

The transmitter portion 102 may include multiple transmitter units 108, 110, 112, 114 producing respective optical signals 116, 118, 120, 122. The optical communication system 100 may operate at any useful wavelength for optical communications, for example in the range 800-950 nm, or over other wavelength ranges, such as 1250 nm-1350 nm, 1500 nm-1600 nm, or 1600 nm-1650 nm. Each transmitter unit 108, 110, 112, 114 is coupled to the optical fiber system 106 via a space division multiplexed (SDM) multiplexer/demultiplexer (“mux/demux”) 124, that directs the optical signals 116, 118, 120, 122 into respective cores of the MCF 128 of the optical fiber system 106. The optical signals 116, 118, 118, 120 may be delivered to the mux/demux 124 via respective single core fibers. Embodiments of the MCF 128 and the SDM mux/demux 124 are discussed below. A multiplexer/demultiplexer is an optical device that, for light traveling in one direction, combines signals from two or more waveguides into a single fiber and, for light propagating in the opposite direction, splits light from a single fiber into two or more waveguides.

The output 126 from the SDM mux/demux 124 comprises different beams that are directed towards the respective cores of the MCF 128. The signals propagate along the optical fiber system 106 to the receiver portion 104, where they are separated by a second SDM mux/demux 130 into the optical signals 116, 118, 120, 122 corresponding to the different cores of the MCF 128 that were excited by light from the SDM coupler 124. Thus, according to this embodiment, the transmitter unit 108 produces an optical signal 116, which is transmitted via a first core of the MCF 128a to the receiver unit 132, the transmitter unit 110 produces an optical signal 118 which is transmitted via a spatial second mode of the concentric MCF 128 to the receiver unit 134, the transmitter unit 112 produces an optical signal 120, which is transmitted via a third spatial mode of the concentric MCF 128 to the receiver unit 136, and the transmitter unit 114 produces an optical signal 122 which is transmitted via a fourth spatial mode of the concentric MCF 128 to the receiver unit 138, with all of the optical signals 116, 118, 120, 122 propagating along the same concentric MCF 128. In this manner, the optical signal 116 may be detected at receiver unit 132 substantially free of optical signals 118, 120 and 122, the optical signal 118 may be detected at receiver unit 134 substantially free of optical signals 116, 120 and 122, the optical signal 120 may be detected at receiver unit 136 substantially free of optical signals 116, 118 and 122, and the optical signal 122 may be detected at receiver unit 138 substantially free of optical signals 116, 118 and 120.

Furthermore, in many optical communications systems there are optical signals propagating in both directions along an optical fiber. This possibility is indicated in FIG. 1A, where the optical signals 116, 118, 120, 122 are designated with double-headed arrows. In such a case, the transmitter units 108, 110, 112, 114 and receiver units 132, 134, 136, 138 may be transceiver units that generate and receive signals that propagate along a respective core of the MCF 128. In other embodiments, there may be a separate transmitter unit and receiver unit for a signal at each end of the optical fiber system 106.

In addition, a signal from a transmitter need not be restricted to only one wavelength. For example, one or more of the transmitter units 108, 110, 112 and 114 may produce respective wavelength division multiplexed signals 116, 118, 120, 122 that propagate along respective cores of the MCF 128. In such a case, the receiver units 132, 134, 136 and 138 may each be equipped with wavelength division demultiplexing units so that the optical signal at one specific wavelength can be detected independently from the optical signals at other wavelengths.

Another embodiment of optical communication system 100′ is schematically illustrated in FIG. 1B. This system 100′ is similar to that shown in FIG. 1A, except the optical fiber system 106 comprises at least two lengths of MCF 128a, 128b which are connected via an add/drop filter 140. The add/drop filter 140 directs light from at least one of the cores of the optical fiber system 106 to a transceiver unit 144 via a fiber link 142. If the add/drop filter 140 directs an optical signal from just one core of the optical fiber system 106, then the fiber link 142 may be a single core fiber, for example a single mode fiber. In the illustrated embodiment, the signal 118 from the second transmitter unit 110 is directed by the add/drop filter 140 to the transceiver 144, with the result that the receiver portion 104 does not receive signal 118. Thus, the add/drop filter 140 ‘drops’ one of the channels passing between the transmitter portion 102 and the receiver portion 104 to the transmitter unit 140.

For optical signals traveling in the opposite direction, the transceiver 144 may direct signals to the second transmitter unit 110 in the transmitter portion 102, in which case the transmitter units 108, 110, 112, 114 may be transceiver units. Thus, the add/drop filter 140 adds a channel to those propagating from the receiver portion 104 to the transmitter portion 102.

An MCF for the purposes of this disclosure is an optical fiber that contains two or more cores laterally displaced from each other within the fiber cladding, where a core is a region of the fiber having a higher refractive index than the surrounding cladding material. There is no requirement that any of the cores is coincident with the axis of the fiber, although one of the cores may be coincident with the fiber axis.

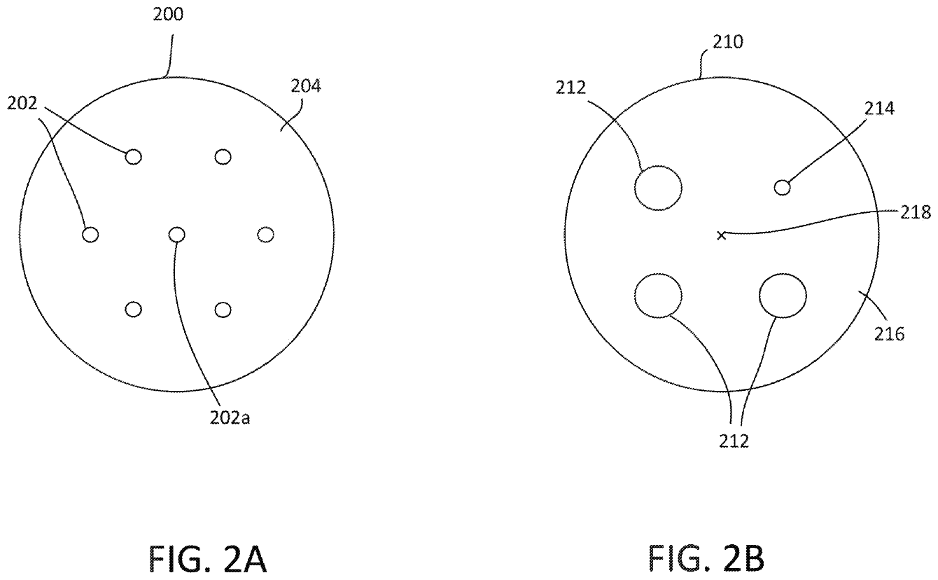

FIG. 2A schematically illustrates a cross-section through an exemplary MCF 200. The MCF 200 includes multiple cores 202 laterally separated from each other within a cladding 204. In this embodiment, the cores 202 are single mode cores. While the cores and cladding can have any suitable dimension, many commercially available silica fibers include single mode cores that have a diameter in the range of around 6-12 μm, typically around 8-9 μm, in a cladding having a diameter of typically in the range 125-150 μm.

FIG. 2B schematically illustrates a cross section through another exemplary MCF 210. In this example, the MCF 210 includes four cores, one single mode core 212 and three multimode cores 214 surrounded by a cladding 216. In some cases, a multimode core 214 may support the propagation of a few modes, in some case fewer than 50 modes, in other cases fewer than 20 modes and in other cases fewer than 10 modes, and typically has a diameter less than 50 μm. Such “few mode” cores in a silica fiber may have a diameter of up to 20 μm.

MCFs have two or more cores, only one of which can be centered on the axis of the fiber. Although it is not a requirement for the invention, the cores of an MCF are typically arranged symmetrically around the axis of the fiber. For example, in the embodiment illustrated in FIG. 2A, the seven cores 202 are arranged with one of the cores 202a located at the fiber axis with the remaining six cores 202 arranged symmetrically around the central core 202a in a regular hexagonal pattern. In an alternative arrangement, the seven cores 202 may be arranged in a heptagonal pattern around the axis of the core. In the embodiment illustrated in FIG. 2B, the cores 212, 214 are arranged with their centers forming a square pattern that is centered on the fiber axis 218. In another embodiment, the single mode core 214 may be positioned on the axis 218, while the multimode cores 212 are positioned symmetrically around the single mode core 214 in the pattern of an equilateral triangle. The MCFs used in the present invention are not limited in the number of cores present, whether they are single or multimode, nor in the geometrical arrangement of the cores within the multicore fiber.

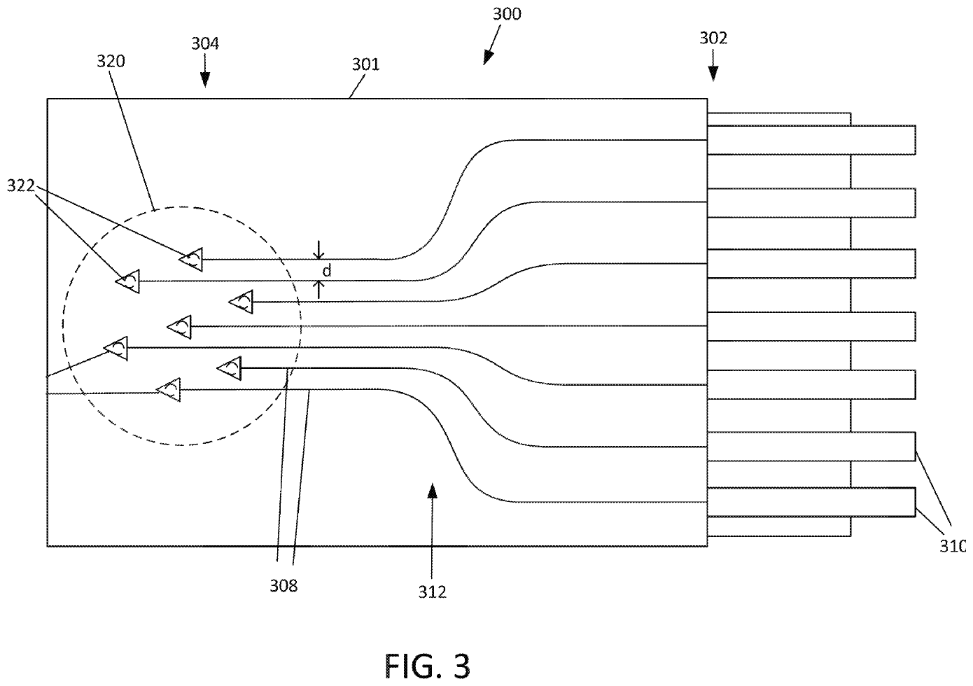

An embodiment of an optical chip device 300 that may be used to couple light between multiple single core fibers and an MCF is schematically illustrated in FIG. 3. The chip device 300 may be used as a mux/demux for coupling light signals from different single core fibers into an MCF, for example as used in the optical systems shown in FIGS. 1A and 1B. The chip device 300 is designed for use with an MCF having seven cores, arranged in a pattern similar to that shown in FIG. 2A, having one central core surrounded by a regular hexagonal pattern of the six other cores. The device 300 includes a substrate 301 having a single core fiber section 302 and a multicore fiber section 304.

The multicore fiber section 304 includes a number of waveguide redirecting elements 306 coupled to waveguides 308. The waveguide redirecting element 306 are any type of element that redirects light that is incident on the waveguide 308 into a direction that propagates along the waveguide 308. The waveguide redirecting element 306 may be, for example, a diffraction grating designed to diffract the incident light in a direction along the waveguide 308, an angled reflecting surface or a coupling prism, or the like.

The waveguide redirecting elements 306 are arranged in a pattern having similar geometry and spacings to the cores in the MCF to which the device 300 is coupled. The waveguides 308 transport light between the multicore fiber section 304 and the single core fiber section 302. Different single core fibers 310 may be aligned to respective waveguides 308. The single core fibers 310 may be single mode fibers or multimode fibers, and may be aligned to the waveguides using any suitable method. In the illustrated embodiment, the cores of the fibers 310 are aligned to their respective waveguides 308 by an alignment block that has V-grooves for positioning the fibers 310 so that their cores align to the waveguides 308. Other methods of aligning the single core fibers 310 to the waveguides 308 may also be used.

The chip device 300 may be formed in any suitable optical chip platform, including silica and silicon. Other chip materials may also be used. The waveguides 308 may be surface waveguides or buried waveguides and may be formed using standard lithographic processes. In the case of a silica device, the waveguides 308 may be formed using different techniques, such as lithographic diffusion methods, or 3D-writing using a femtosecond laser. In the case of a silicon device, the waveguides 306 may be formed of silicon, silicon nitride, or any other suitable semiconducting alloy. Likewise, the waveguide redirecting elements 306, if in the forms of waveguide gratings, may be formed on the surface of the device 300 or may be buried, and may be formed in silica and silicon using standard lithographic processes.

In some embodiments, the lateral separation, d, between pairs of adjacent waveguides 308 in the single core fiber section 302, close to the redirecting features 306, may be substantially the same across all waveguides 308. Between the multicore fiber section 304 and the single core fiber section 302, the waveguides 308 preferably fan out in a fan out section 312 so as to provide greater spacing between waveguides 308 in the single core fiber section 302.

The positioning of the end of an MCF 320 and its cores 322 over the chip device 300 are shown in dashed lines. The MCF 320 is aligned to the device 300, with each of the seven cores 322 of the MCF 320 lining up with respective gratings 306 of the chip device 300, so that light exiting a core 322 of the MCF 320 is redirected along its respective waveguide 308, and vice versa.

It will be appreciated that chip device 300 is not illustrated drawn to scale. In most applications, the diameter of the multicore fiber 320 will be approximately the same, if not the same, as that of the single core fibers 310. However, the details of the multicore fiber section 304 of the device 300 are shown expanded in the figure for clarity of the description.

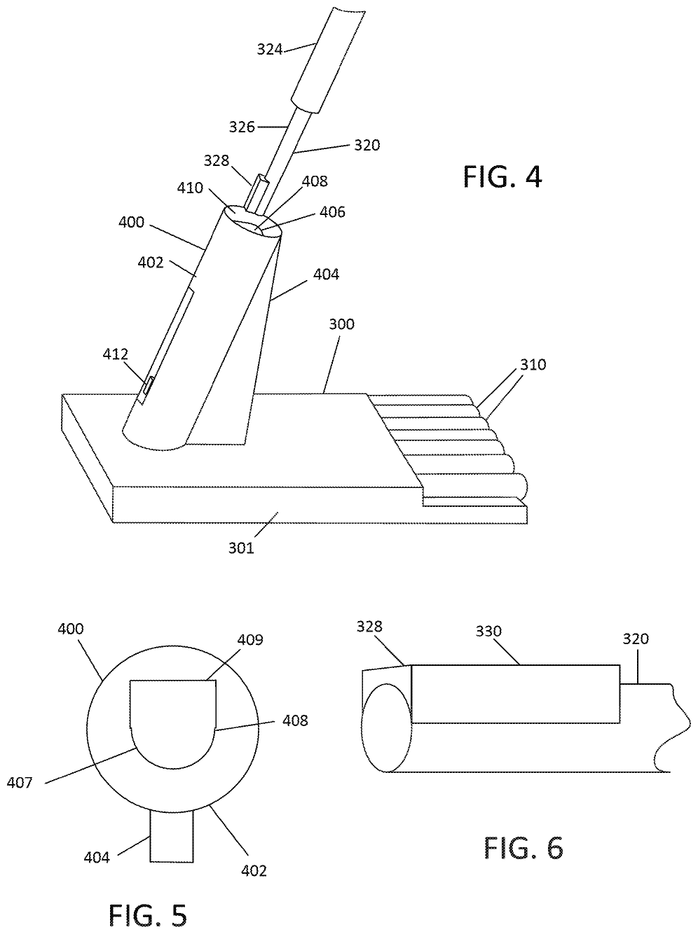

FIG. 4 shows a perspective view of an exemplary optical unit that employs a fiber holder 400 mounted on top of the chip device 300. The fiber holder 400 is used to hold the MCF 320 in a position such that its cores 322 align with their respective redirecting features 306 in the chip device 300. The fiber holder 400 includes a body 402 and may include one or more fins 404 to provide support. In configurations where the body 402 is tilted, a single fin may be used provide in the direction of the body's tilt. The body 402 has an aperture 406 at its top, the aperture 406 leading to a channel 408 within the body 404. The body 402 may include a tapered lip 410 at the aperture to aid in inserting the MCF 320 into the channel 408. A cross-sectional view of the fiber holder 400 is schematically illustrated in FIG. 5. The channel 408 may comprise a round portion 407 to conform to the outer surface of the MCF 320 and a slot portion 409 to conform to the alignment feature 328.

In this embodiment, the cover 324 of the MCF 320 is pared back from the fiber end to expose its cladding 326. An alignment feature 328 is provided at, or close to, the end of the MCF 320 to aid in its alignment, as shown in greater detail in FIG. 6. In the illustrated embodiment, the alignment feature 328 has a substantially flat surface 330. Other shapes of alignment feature 328 may be used. For example, the alignment feature 328 may be curved, peaked or the like.

The alignment feature 328 may be applied to the MCF 320 in any suitable manner. In one embodiment, the alignment feature 328 may be fabricated, for example through precision molding or precision 3D printing, and then attached to the MCF 320.

In another approach, the alignment feature 328 may be 3D-printed directly on the MCF 320 using 2-photon femtosecond laser writing. The use of 2-photon femtosecond laser writing permits accurate control of the written feature with sufficient precision to achieve the tolerances associated with matching the fiber cores to the waveguide redirecting elements. 2-photon femtosecond laser writing can achieve resolution in the submicron range, typically around 200 nm. The material used to write the alignment feature 328 is a photoresist, for example IP-S or IP-Dip from Nanoscribe GmbH, Germany. It is preferred that the surface of the fiber cladding be prepared prior to 3D-writing by silanization, i.e. exposing the glass surface on which the alignment feature is to be written to a silane, such as 3-(Trimethoxysilyl)propyl methacrylate. For example, the end of the MCF 320 may simply be dipped into the silane. It has been found that silanization of the glass surface prior to 3D-writing enhances the bond strength of the bond between the alignment feature 328 and the fiber 320. The exposure power used in the 3D-writing process depends on various factors such as writing speeds, desired resolution and the photoresist employed.

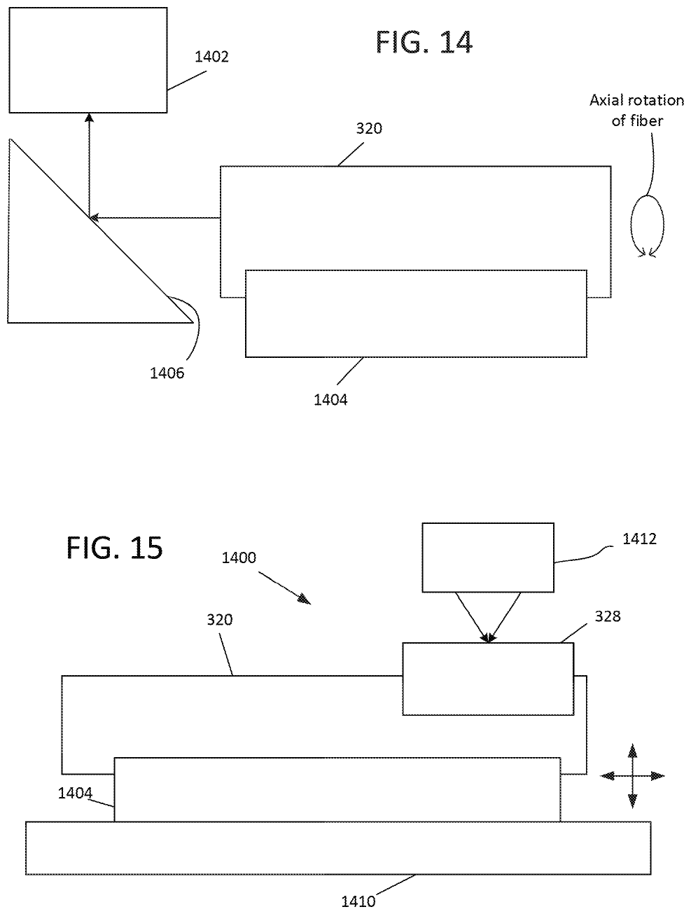

One approach to making sure the alignment feature 328 is in the correction rotational orientation relative to the cores 322 of the MCF 320 is now discussed with reference to FIG. 14. In this approach, the end of the MCF 320 is imaged by a microscope 1402. The MCF 320 is positioned horizontally on a flat substrate 1404 that preferably has a structure, such as a V-groove, for maintaining the position of the fiber 320. The MCF 320 is rotated about its axis while monitoring the positions of the cores 322 via the microscope 1402. The fiber end may be imaged via a reflector 1406. Once the fiber MCF 320 is rotationally aligned, it may be fixed to the substrate 1404 using an adhesive, such as a UV-curable adhesive.

The substrate 1404, with the MCF 320 attached, is then mounted on a translation stage 1410, for example a piezo-driven stage, of the 3-D writing system 1400, as schematically illustrated in FIG. 15. The light beam from a femtosecond laser is focused via a lens 1412, such as a microscope objective, towards the MCF 320. Commonly, the MCF 320 and the output side of the lens 1412 are immersed in the photoresist. The 3-D writing system is then used to write the alignment feature 328 in the conventional manner.

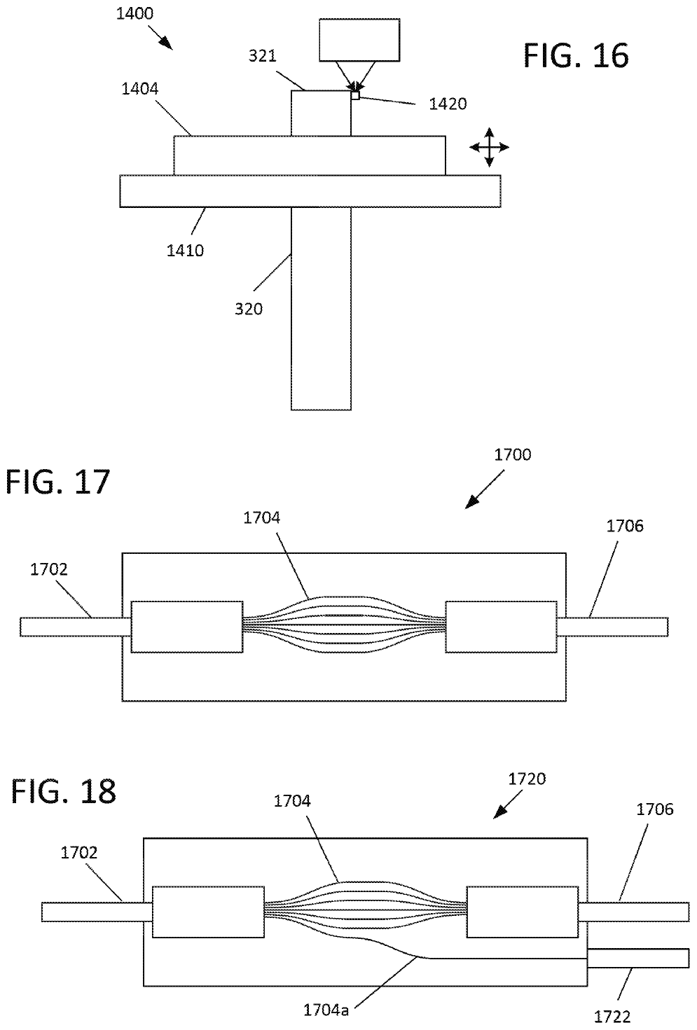

In the case that the individual cores 322 of the MCF 320 cannot be easily visualized using the setup described with reference to FIG. 14, a preliminary alignment step may be followed, as is now discussed with reference to FIG. 16. In this method, the fiber 320 is aligned end-on in the 3D-writing system 1400 so the user can visualize the end face 321 of the MCF 320, and its cores 322 and the manufacturer's orientation marker. A low-height alignment feature 1420, rotationally aligned with the MCFs cores 322 is then printed at the side surface at the end of the MCF. The MCF 320 can then be oriented horizontally and the alignment feature 328 printed on the MCF 320 using the low-height alignment feature as a guide, using the method described above.

The MCF 320, with the alignment feature 328 at its end, may be passed through the aperture 406 and guided down the channel 408 to the bottom of the body 402. The channel 408 is shaped to receive the MCF 320 and the alignment feature 328. The alignment feature 328 is positioned on the MCF 320 such that, when passing through, and oriented by, the channel 408, the fiber cores 322 are aligned with their respective redirecting features 306 on the chip device 300, so as to direct light from the cores 322 into their respective waveguides 308, and vice versa, or from the waveguides 308 into respective cores 322 of the MCF 320.

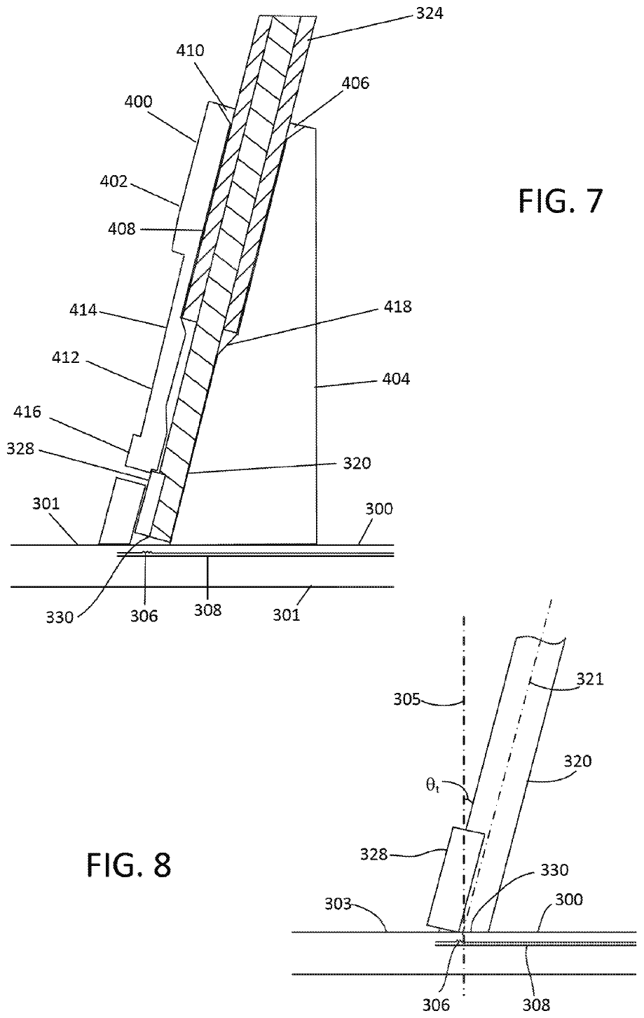

A cross-sectional view through the fiber holder 400 is schematically illustrated in FIG. 7, showing the body 402 and fin 404. The MCF 320 is in its aligned position within the channel 408: the end 330 of the MCF 320 is at the surface of the chip device 300, and the fiber cores 322 are aligned with their respective redirecting features 306. The body 402 may be provided with a lock 412 to secure the MCF 320 in the holder 400. In the illustrated embodiment, the lock 412 includes a resilient arm 414 and a locking head 416 that interferes with the alignment feature 328 once the MCF 320 is in its aligned position. When the MCF 320 is being inserted along the channel 408 of the fiber holder, the MCF 320 pushes past the locking head 416, moving it radially outwards from the channel 408. Once the alignment feature 328 has passed locking head 416, the locking head 416 can spring back radially inwards towards the channel 408, to a position that prevents the alignment feature 328 from being moved up the channel 408 in a direction away from the chip device 300. In this manner, the fiber holder 400 can at least partially hold the MCF 320 in the aligned position. An adhesive, such as a UV curable adhesive may also be inserted within the channel 408 to hold the MCF 320 in position. This may be particularly suitable if there is no intention of releasing the MCF 320 from the fiber holder 400. Other types of locking mechanism may be provided to hold the MCF 320 in place within the fiber holder 400, either with or without adhesive. In other embodiments, the holder 400 may not have a locking mechanism, in which case the MCF 320 may be held in its aligned position using an adhesive.

In some embodiments, the channel 408 may also be provided with a shoulder 418 that separates an upper region 420 of the channel 408, having a larger internal dimension, from a lower region 422 of smaller internal dimension. The shoulder 418 may be positioned so that the portion of MCF 320 below the shoulder 418 has bare cladding, while the portion of MCF 320 above the shoulder 418 includes a cover 324 over the cladding.

In the illustrated embodiment, the MCF 320 is not perpendicular to the upper surface 303 of the optical chip device 300, so the end 330 of the MCF does not lie flat on the surface 303.

However, efficient coupling between the MCF 320 and the waveguides 308 is still possible at non-zero tilt angles.

In other embodiments, for example as schematically illustrated in FIG. 8 (which omits the fiber holder 400 for clarity) the end 330 of the MCF 320 is not perpendicular to the fiber axis, but is at an angle close to, or equal to, the tilt angle, θₜ, allowing the end face 330 to sit parallel, or close to parallel with the upper surface 303 of the chip device 300. The angle on the end face 330 may be obtained, for example, by polishing the MCF 320, before or after the alignment feature 328 is attached to the MCF 320. The alignment feature 328 may be set back from the end face 330 sufficient so that it is not also polished at an angle, as illustrated. In other embodiments, where the alignment feature 328 is closer to the end face 330, the alignment feature 328 may be polished at an angle along with the end face 330.

In the case of a grating waveguide coupler, the value of the tilt angle depends on a number of parameters, such as the effective index of refraction of the guided mode within the waveguide, grating period, etch depth of the grating into the waveguide, the thickness of the waveguide, and the angle of incidence. The design of a grating for coupling light into and out of a waveguide is known to one of ordinary skill.

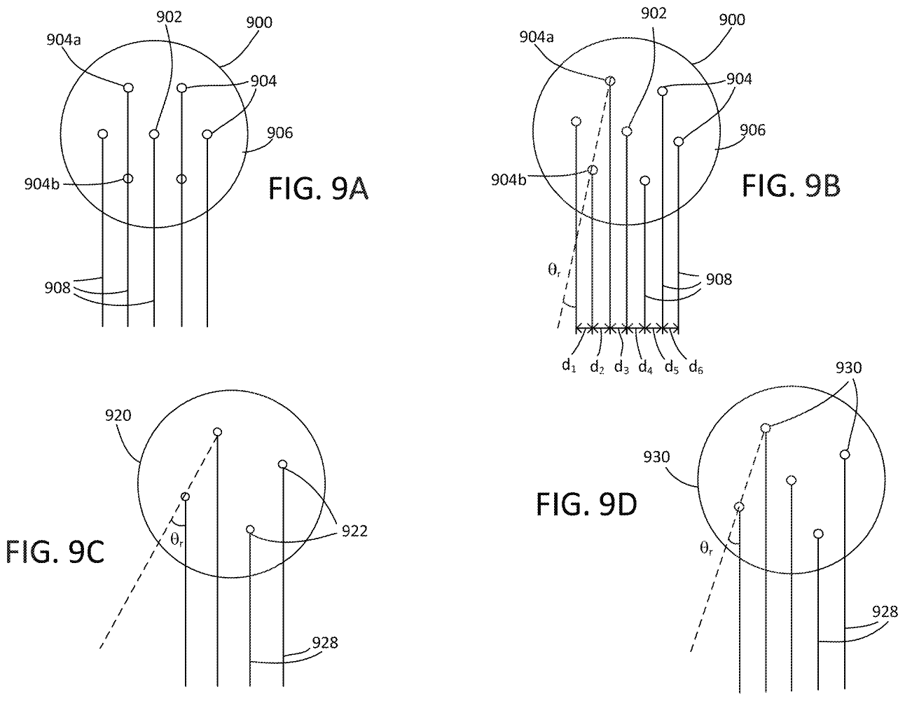

As has already been discussed, one embodiment of MCF that may be used with the present invention is a seven core MCF. An example of a seven core MCF 900 is schematically illustrated in FIG. 9A, having a central core 902 surrounded by outer cores 904 arranged in a hexagonal pattern. Such a fiber is commercially available as MCF-007 1 from Chiral Photonics Inc., Pine Brook, N.J. The diameter of the cladding 906 for this fiber is nominally 150 μm, and the single mode cores have a core diameter of 8-9 μm. The outer cores 904 are radially positioned about 45 μm from the central core 902 and the spacing between adjacent outer cores 904 is also about 45 μm. If the hexagonal pattern formed by the outer cores is oriented symmetrically relative to a set of parallel waveguides 908, and the cores projected to the waveguides 908, it is apparent that there is overlap between waveguides associated with some of the cores 904. For example, cores 904a and 904b lie over the same waveguide. However, by rotating the fiber through a rotation angle, Or, the waveguides 908 associated with each core 902, 904 become separated from each other. For the seven core MCF 900, a rotation angle of θᵣ=10.893° will result in each of the waveguides 908 being equally separated by a distance, d, from its adjacent neighbors. In other words, d=d₁=d₂=d₃=d₄=d₅=d₆. For the fiber dimensions listed above, d=14.7 μm. It is not required that all the waveguides 908 be separated equally from their adjacent neighbors, however it may be preferred in order to reduce cross-coupling between adjacent waveguides 908.

Multicore fibers having different numbers of cores can similarly be rotated from a symmetric position relative to a set of parallel waveguides in order to couple to equally spaced waveguides. For example, FIG. 9C schematically represents a four core MCF 920 rotated so that its cores 922 couple to respective waveguides 928. In this case, the value of Or is 18.433°. FIG. 9D schematically represents a five core MCF 930 rotated so that its cores 932 couple to respective waveguides 938. In this case, the value of Or is 26.565°. It should be noted that, in many cases where the number of cores in the MCF is odd, one of the cores is positioned centrally, on the fiber's axis, with the remaining cores positioned around the central core, spaced equidistantly from the central core and the other cores.

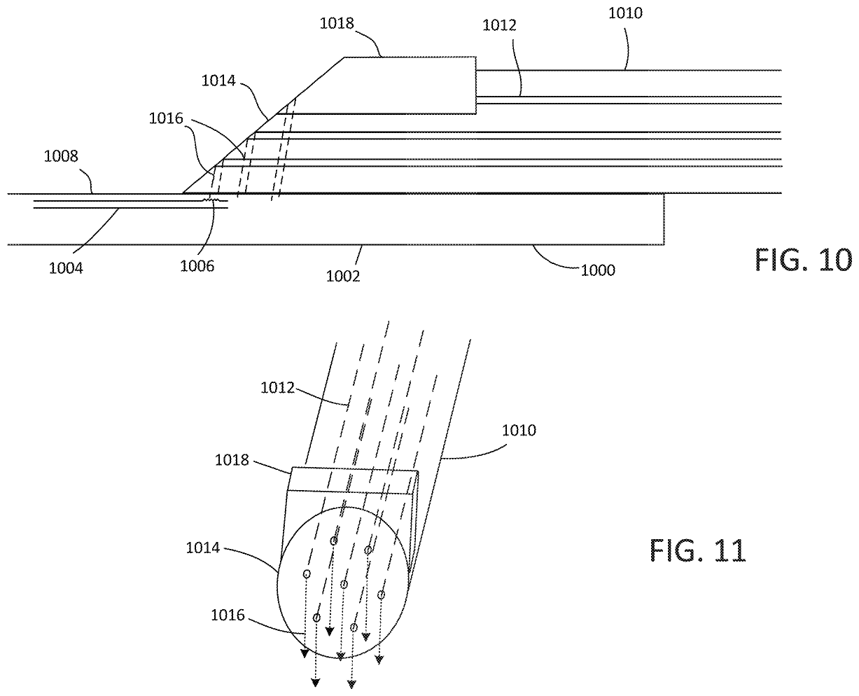

The approaches discussed above relate to coupling light into and out of an MCF via its end face. Another approach to coupling light between an MCF and another element such as an optical chip is to couple the light out of the side of the MCF. An embodiment of the invention using this approach is schematically illustrated in FIG. 10. An optical chip 1000 comprises a substrate 1002 with a number of waveguides 1004. The waveguides 1004 are provided with waveguide redirecting features 1006, such as gratings or the like. An MCF 1010, having multiple cores 1012, is positioned parallel to the upper surface 1008 of the optical chip 1000 in a “side-coupling” arrangement. The end face 1014 of the MCF 1010 is angled so that light propagating along the cores 1012 is reflected by the end face 1014 downwards towards the optical chip 1000 as freely propagating beams 1016. Reflection at the end face 1014 may be via a reflective coating on the end surface 1014, or via total internal reflection.

Like the previously described embodiment, the waveguide redirecting features 1006 are advantageously arranged in a pattern on the chip 1000 that couple to the beams 1016.

FIG. 11 shows the pattern of the beams 1016 as they are incident on the surface of the chip 1000 (shown as arrow heads), and the waveguide redirecting features 1006 are positioned in the chip 1000 accordingly.

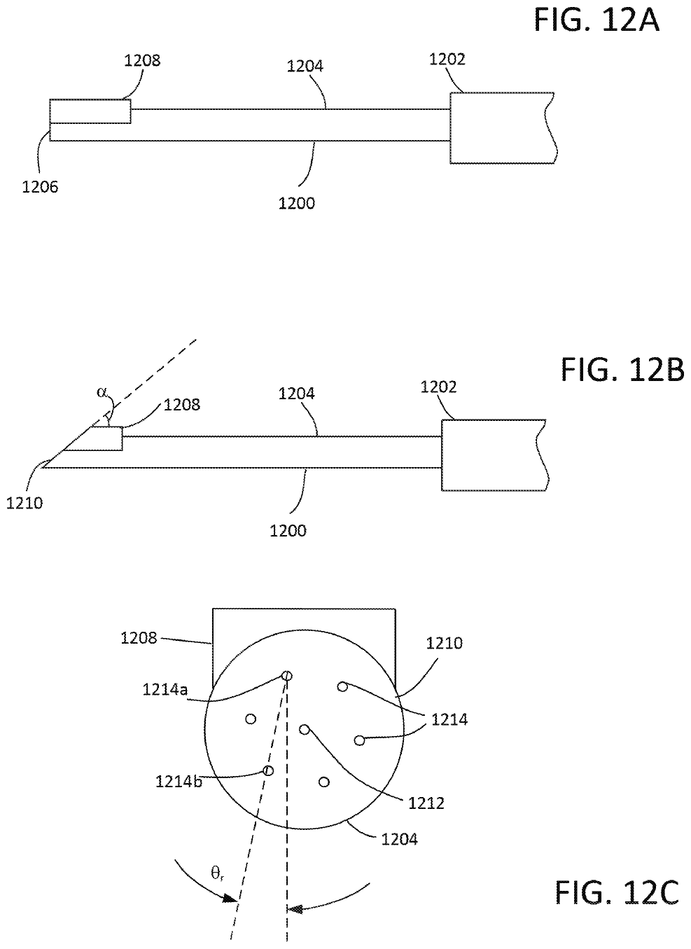

FIGS. 12A-12C schematically illustrate one approach to preparing the MCF 1200 for use in the side-coupled arrangement. FIG. 12A shows the MCF 1200, with the cover 1202 pared away from the cladding 1204 in that part of the MCF 1200 near its end 1206. An alignment feature 1208 is attached to the MCF 1200 proximate or, as illustrated, at the fiber end 1206. The alignment feature 1208 may be applied to the MCF 1200 in the same manner as described above, such as using 2-photon femtosecond 3D-writing.

The end 1206 of the fiber may then be polished to produce the desired angle on the end face 1210. FIG. 12B schematically illustrates the MCF 1200 after polishing the end face 1210 to an angle, a. In some applications, a may be around 40°. The end face 1210 may be polished in a single step, or may be polished in multiple steps. For example, the end face 1210 may be polished in two steps, a first step to 20° and the second step to 40°. The end face 1210 may also be polished in more steps, such as four steps, each one increasing the polishing angle by 10°, to achieve a finished polish angle of 40°.

FIG. 12C schematically illustrates an end-on view of the angle end face 1210, showing the central core 1212 and the surrounding cores 1214, with the alignment feature 1208. In the illustrated embodiment, the MCF 1200 has seven cores, formed by the central core 1202, with the surrounding cores 1204 forming a regular hexagonal pattern around the central core. As with the MCF in the previously described embodiment, the MCF 1200 is rotated about its axis by an angle of Or to ensure separation of the parallel waveguides associated with the beam of light from each core 1202, 1204. In the case of this seven core MCF, the angle θᵣ is 10.893°.

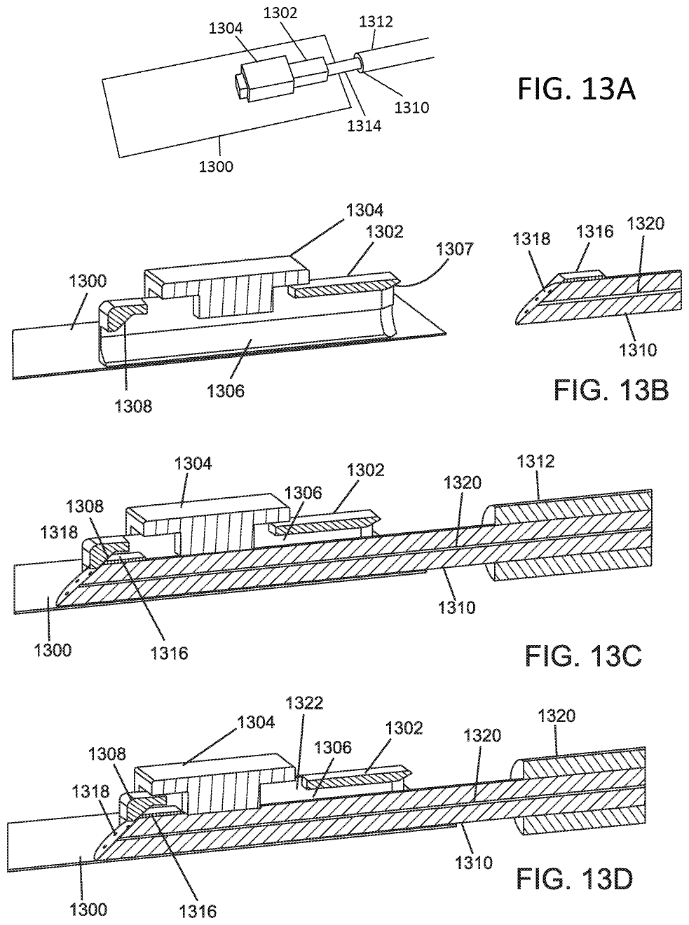

FIG. 13A schematically illustrates an embodiment of a side-coupled connection between an optical chip 1300 and an MCF 1310.

The MCF 1310 has its cover 1312 pared back from the fiber end, to expose the cladding 1314. The end of the MCF 1310 is held within a fiber holder 1302 on the optical chip 1300. The fiber holder 1302 includes a locking mechanism 1304 that is used to hold the MCF 1310 in place. The fiber holder 1302 and locking mechanism 1304 may be 3D printed parts, for example written using 2-photon femtosecond 3D-printing directly on the surface of the chip 1300. Other approaches to fabricating the fiber holder 1302 may be used, for example precision molding.

FIGS. 13B-13D present schematic cross-sectional views of the chip 1300, fiber holder 1302 and MCF 1310, to illustrate how this embodiment of fiber holder 1302 may be used to locate an MCF 1310. FIG. 13B shows the MCF 1310 prior to insertion into the fiber holder 1302. The fiber holder 1302 is mounted on the optical chip 1300. The fiber holder 1302 defines an interior channel 1306 that lies parallel with the surface of the chip 1300 to receive the MCF 1310. The channel 1306 has a cross-sectional profile shaped to receive the MCF 1310 and the alignment feature 1316 at the end of the MCF. The opening 1307 of the channel 1306 that receives the MCF 1310 may be tapered in order to improve the ease with which the MCF 1310 is inserted into the channel 1306. At the other end of the housing, the channel 1306 has a shoulder 1308, or other physical feature, for preventing passage of the end 1318 face of the MCF 1310 beyond a desired location. The locking mechanism 1304 is in its open position, to allow free passage of the MCF 1310.

In FIG. 13C, the MCF 1310 has been pushed through the channel 1306 of the fiber holder 1302 to its aligned position, where the cores 1320 of the MCF 1310 are in alignment with their respective waveguide redirecting elements. At this position, the shoulder 1308 interacts with the MCF 1310, for example by contacting one or both of the end face 1318 and the alignment feature 1316. The locking mechanism 1304 is still in the open position.

In FIG. 13D, the locking mechanism 1304 has been pushed into a locking position, which locks the MCF 1310 in its aligned position. The locking mechanism may lock the MCF 1310, for example by contacting a sloped rear edge of the alignment feature 1316. The MCF 1310 may be held in its aligned position by the locking mechanism 1304 alone, or an adhesive, for example a UV curable such as the NOA range of adhesives, available from Norland Products, Cranbury, N.J., may additionally be used along with the locking mechanism 1304. For example, the adhesive may be introduced to the channel 1306 via an upper slot 1322 in the fiber holder 1302. The upper slot 1322 may provide freedom of movement for the locking mechanism 1304.

In other embodiments, the fiber holder 1302 may use adhesive alone to hold the MCF 1310 in its aligned position. For example, the holder 1302 may not include a locking mechanism, but still retain an upper slot 1322. Once the MCF 1310 has been located in its alignment position, the adhesive may be inserted into the channel 1306 by the upper slot 1322.

While the description above provided a particular example of an optical chip device being uses as a mux/demux, it will be appreciated that the invention may be used to couple light between an MCF and a set of waveguides used in any type of optical device. For example, as schematically illustrated in FIG. 17, an optical device 1700 may include a first MCF 1702 coupled to an optical chip using any of the techniques described above, to couple light from the MCF 1702 to a set of waveguides 1704. The waveguides 1704 may then couple to a second MCF 1706, again using any of the techniques described above for coupling light between an MCF and waveguides in an optical chip. Thus, the device 1700 operates as an MCF-MCF coupler.

Another device 1720 is schematically illustrated in FIG. 18. The device 1720 is like that just described, except that one of the waveguides 1704a couples between the first MCF 1702 and a single core fiber 1722. In this case, light from one of the cores of the firsts MCF 1702 is coupled out of the main pathway to the single core fiber 1722, while light from the other cores of the first MCF is coupled to the second MCF 1706. Thus, this device 1720 operates as an add/drop filter.

Other types of devices may employ the MCF-waveguide coupling techniques described above. For example, an add/drop filter may add/drop light from more than one core of the MCF. In another variation, the device may have switched outputs so as to be reconfigurable. In another variation of add/drop filter used in a wavelength division multiplexed (WDM) system, signals from the different cores of a multicore fiber may be separated into respective waveguides on a chip, and then the signal passing along at least one of the waveguides is passed through a WDM add/drop filter to split off one of the wavelength channels. The channels for that waveguide are then WDM remultiplexed and before the signals from all waveguides are recombined into a second MCF.

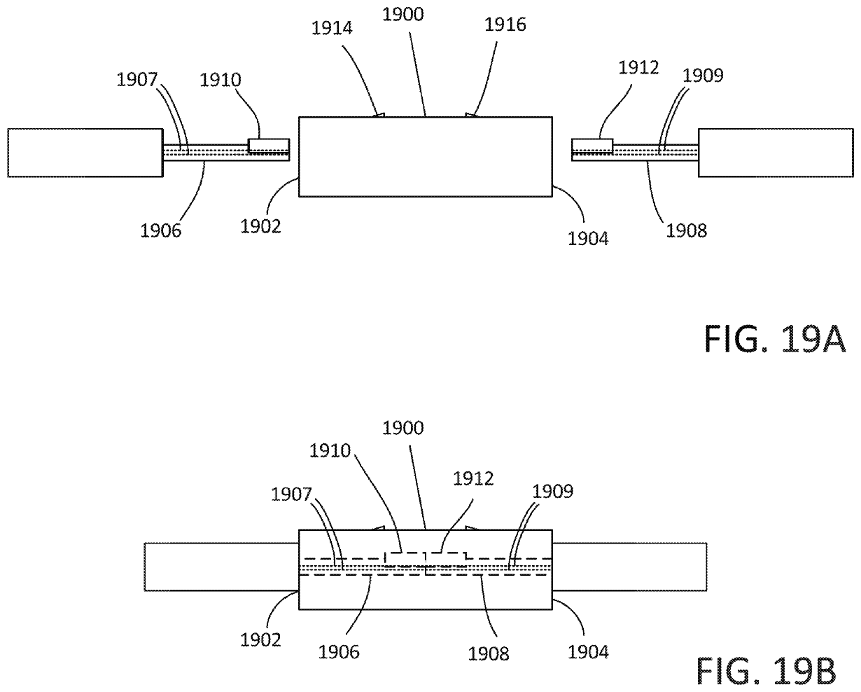

In another embodiment of the invention, 3-D printed alignment features on the ends of a pair of MCFs may be used to simplify alignment of the MCFs in a simple coupler. One embodiment of such an approach is schematically illustrated in FIG. 19A, in which a fiber coupler 1900 has open ends 1902, 1904 to receive respective MCFs 1906, 1908. MCF 1906 has multiple cores 1907 and a 3-D printed alignment feature 1910 at, or close to, its end. MCF 1908 has multiple cores 1909 and a 3-D printed alignment feature 1912 at, or close to, its end. The 3-D alignment features 1910, 1912 may be fabricated using any of the techniques discussed above.

Each open end 1902, 1904 of the coupler 1900 is provided with a channel to receive its respective MCF 1906, 1908, and with a complementary slot for the respective alignment feature 1910, 1912, for example in a manner similar to that discussed above for the fiber holders used for coupling to optical chips. In this manner, the coupler 1900 can receive the MCFs 1906, 1908 correctly oriented so that optical signals may be efficiently coupled respective cores of the MCFs 1906, 1908. The coupler 1900 may also be provided with locking mechanisms 1914, 1916 to lock the MCFs 1906, 1908 in position within the coupler 1900.

FIG. 19B schematically illustrates the MCFs 1906, 1908 in their aligned positions within the coupler 1900, with respective pairs of cores 1907, 1909 in alignment so that light may couple between the cores 1907, 1909 of the MCFs 1906, 1908.

Finally, the description of the various devices described herein may have described the propagation of optical signals in a single direction, mainly from the MCF to the optical chip device. It will be understood, of course, that optical signals may also propagate in the opposite direction, and there is no intention in the present description to limit the direction in which optical signals propagate through the claimed optical devices.

As noted above, the present invention is applicable to fiber optical communication and data transmission systems. Accordingly, the present invention should not be considered limited to the particular examples described above, but rather should be understood to cover all aspects of the invention as fairly set out in the attached claims.

What we claim as the invention is:

1. An optical device comprising:
a first multicore optical fiber having at least two cores laterally separated from each other within a cladding, the first multicore optical fiber having a first end;
an alignment feature attached on the first multicore fiber proximate the first end of the first multicore optical fiber;
a substrate comprising at least two waveguides, each of the at least two waveguides comprising a redirecting feature; and
a fiber holder on the substrate, the fiber holder being configured to receive the first multicore optical fiber and comprising an alignment channel to receive the alignment feature;
wherein, when the first multicore optical fiber is in an aligned position within the fiber holder, the first multicore optical fiber is rotationally aligned around its axis by an interaction between the alignment feature on the first multicore fiber and the alignment channel of the holder so that the at least two cores are aligned to optically couple light between the at least two cores and respective redirecting features of the at least two waveguides.

2. An optical device as recited in claim 1, wherein light propagating from a core of the first multicore fiber to its respective redirecting feature passes through an end face of the first multicore optical fiber.

3. An optical device as recited in claim 2, wherein the end face of the first multicore optical fiber is substantially perpendicular to an axis of the first multicore optical fiber.

4. An optical device as recited in claim 2, wherein the end face of the first multicore optical fiber is substantially parallel to an upper surface of the substrate.

5. An optical device as recited in claim 1, wherein light propagating from a core of the first multicore fiber to its respective redirecting feature is reflected at an end face of the first multicore optical fiber and exits the first multicore fiber through the side of the first multicore optical fiber.

6. An optical device as recited in claim 1, wherein the alignment feature is positioned substantially on one side of the first multicore optical fiber.

7. An optical device as recited in claim 1, wherein the keying feature is 3D-printed onto the side of the first multicore optical fiber at the first end.

8. An optical device as recited in claim 1, wherein the fiber holder is 3D-printed on the substrate.

9. An optical device as recited in claim 1, wherein the fiber holder further comprises a locking feature to at least partially hold the first multicore optical fiber in the aligned position.

10. An optical device as recited in claim 9, wherein the locking feature interacts with the keying feature on the first multicore fiber to at least partially hold the first multicore fiber in the aligned position.

11. An optical device as recited in claim 1, further comprising an adhesive adhering the first multicore optical fiber to the fiber holder in the aligned position.

12. An optical device as recited in claim 1, wherein the alignment channel of the fiber holder comprises a slot configured to receive the alignment feature, thereby providing a desired rotational alignment to the first multicore fiber for coupling to the redirecting features of the at least two waveguides.

13. An optical device as recited in claim 1, wherein the fiber holder holds the first multicore fiber substantially nonparallel to the substrate.

14. An optical device as recited in claim 1, wherein the fiber holder holds the first multicore fiber substantially parallel to the substrate.

15. An optical device as recited in claim 1, wherein the redirecting features comprise waveguide gratings.

16. An optical device as recited in claim 1, wherein the first multicore fiber comprises at least three cores and the substrate comprises at least three waveguides, each of the at least three waveguides comprising a redirecting feature, lateral separation between adjacent pairs of waveguides, proximate their respective redirecting features, being equal.

17. An optical device as recited in claim 1, further comprising at least two single core fibers, each of the at least two single core fibers being optically coupled to a respective waveguide of the least two waveguides.

18. An optical device as recited in claim 1, further comprising a second multicore fiber, at least one of the at least two waveguides being coupled to a respective core of the second multicore fiber.

19. An optical device as recited in claim 18, further comprising a single core fiber, one of the at least two waveguides being coupled to the single core fiber.

20. An optical device comprising:
a first multicore optical fiber having at least two cores laterally separated from each other within a cladding, the first multicore optical fiber having a first end;
a first alignment feature attached on the first multicore fiber proximate the first end of the first multicore optical fiber;
a second multicore optical fiber having at least two cores laterally separated from each other within a cladding, the second multicore optical fiber having a second end;
a second alignment feature attached on the second multicore fiber proximate the second end of the second multicore optical fiber;
a coupler element having a first channel opening at a first end of the coupler element, the first channel being shaped to receive the first multicore fiber and the first alignment feature, the coupler element also having a second channel opening at a second end of the coupler element, the second channel being shaped to receive the second multicore fiber and the second alignment feature; and
wherein, when the first multicore optical fiber is in an aligned position within first channel of the coupler element and the second multicore optical fiber is in an aligned position within the second channel of the coupler element, the first multicore optical fiber and second multicore optical fiber are rotationally aligned around their axes so that the at least two cores of the first multicore fiber are aligned to respective ones of the at least two cores of the second multicore optical fiber.
